(19) United States
(12) Patent Application Publication
(10) Pub. No.: US 2003/0035380 A1
(43) Pub. Date: Feb. 20, 2003

(54) Node management system

(76) Inventors: Andrew P. Downing, West Pennant Hills (AU); Andrew R. Rutherford, Darlinghurst (AU); Kong Y. Lai, San Souci (AU)

Correspondence Address: WILDMAN, HARROLD, ALLEN & DIXON, 225 WEST WACKER DRIVE, CHICAGO, IL, 60606, US

(21) Appl. No.: 10/213,745

(22) Filed: Aug. 6, 2002

(30) Foreign Application Priority Data
Aug. 15, 2001 (AU) PR7058

(51) Int. Cl. H04L 12/28

(52) U.S. Cl. 370/255; 370/400

(57) ABSTRACT

A system and method for management of nodes. Nodes are grouped together in a node group according to selected criteria. The node group is repeatedly re-evaluated, at predetermined intervals, based on the selected criteria. A selection of at least one node and/or node group is facilitated, and the selected at least one node and/or node group is queried. The system in one instance is implemented as a computer software program, which can be carried on a computer readable medium.

### FIELD OF INVENTION

The present invention relates to a node management system for managing distributed nodes in a computing system.

### BACKGROUND OF INVENTION

In the present specification, the term “node” will be understood to mean any part of a networked computing system that is capable of providing data on request in accordance with a predetermined format.

It is known to provide a node management system for monitoring a plurality of distributed nodes which operates by facilitating selection of query criteria and by interrogating each node in the system on the basis of the selected query criteria.

While such systems operate well for systems which include a relatively small amount of nodes (of the order of 100 nodes), for systems which include a relatively large number of nodes (of the order of 1000 nodes), operation of the system becomes impractical since it becomes impossible to interrogate all nodes of the system in a reasonable time and without incurring excessive financial cost.

### SUMMARY OF INVENTION

In accordance with a first aspect of the present invention, there is provided a node management system, said system including:

means for grouping nodes together in a node group according to selected criteria, and for repeatedly re-evaluating the node group based on the selected criteria at predetermined intervals;

means for facilitating selection of at least one node and/or node group; and

means for querying the selected at least one node and/or node group.

The selected criteria may be based on node location, on device type and/or on at least one aspect of operation of the nodes. The at least one aspect of operation of the nodes may be defined using a conditional expression.

Preferably, the means for grouping nodes together, the means for facilitating a selection of at least one node and/or node group, and the means for querying the selected at least one node and/or node group are implemented by a management application and a user interface device.

Preferably, the node group is re-evaluated at a predetermined interval, preferably once per day.

The means for grouping nodes together may be arranged to group nodes together in node groups and sub-node groups.

Preferably, the system is arranged to display nodes to a user in the form of a managed nodes tree, and the system is arranged to display selected nodes and/or node groups to a user in the form of a selected nodes tree.

Preferably, the means for facilitating selection of at least one node and/or node group includes means for facilitating transferral of nodes from the managed nodes tree to the selected nodes tree.

Preferably, the means for facilitating selection of at least one node and/or node group includes means for facilitating exclusion of at least one node and/or node group from the selected nodes tree.

In accordance with a second aspect of the present invention, there is provided a method of managing nodes, said method including the steps of:

grouping nodes together in a node group according to selected criteria;

repeatedly re-evaluating the node group on the basis of selected criteria at predetermined intervals;

facilitating selection of at least one node and/or node group; and

querying the selected at least one node and/or node group for information.

In accordance with a third aspect of the present invention, there is provided a computer software program arranged to instruct a computing system to operate in accordance with a system according to the first aspect of the present invention.

In accordance with a fourth aspect of the present invention, there is provided a computer readable medium carrying a computer software program according to the third aspect of the invention.

### BRIEF DESCRIPTION OF THE DRAWINGS

The present invention will now be described, by way of example only, with reference to the accompanying drawings, in which:

FIG. 1 is a block diagram of a node management system in accordance with an embodiment of the present invention;

FIG. 2 is an example of a node management tree of the system shown in FIG. 1; and

FIGS. 3 to 6 show example screens of the system shown in FIG. 1.

### DESCRIPTION OF AN EMBODIMENT OF THE PRESENT INVENTION

In the following description of an embodiment of the invention, it will be understood that the invention may be implemented as hardware and/or software using an appropriate platform such as a computing system.

The present invention broadly relates to a system and corresponding method which enables like nodes to be dynamically grouped together according to selected criteria. In this specification, such groupings of nodes are termed “node groups”. Each node group is maintained current by periodically re-evaluating the nodes managed by the system so that all nodes having the relevant selected criteria are included in the appropriate node groups. Once the nodes have been grouped together in this way, a user is able to query selected nodes and/or selected node groups only and, in this way, the time taken to carry out a query and the cost associated with a query can be reduced.

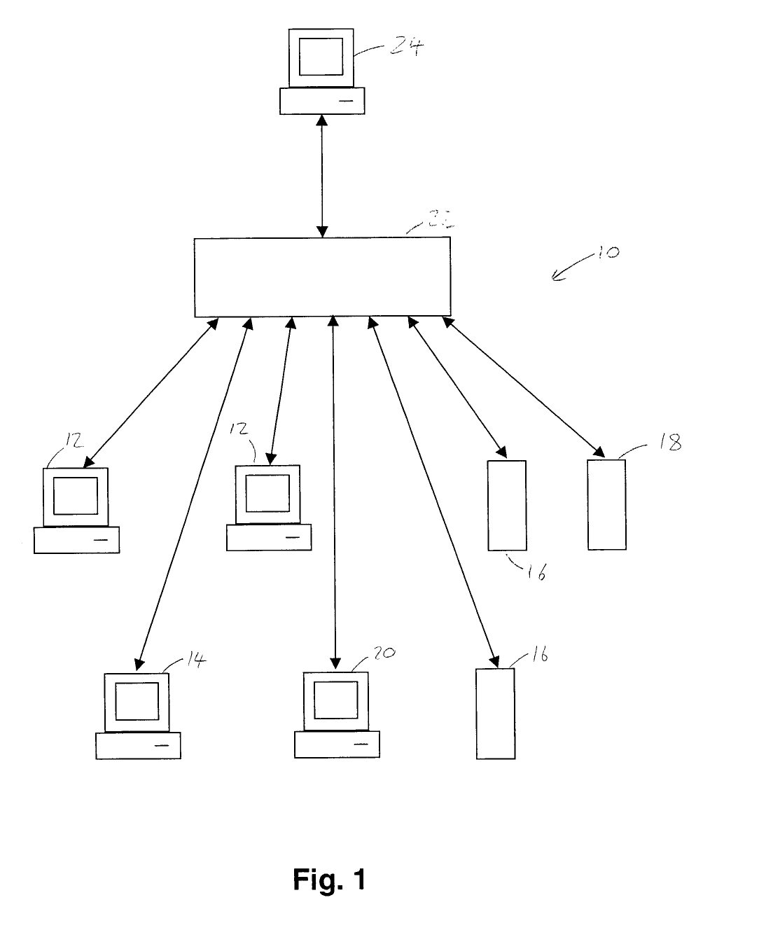

Referring to the drawings, in FIG. 1 there is shown a node management system 10 for managing a plurality of distributed managed nodes 12, 14, 16, 18, 20.

In this example, the managed nodes include Windows 2000 workstations 12, a Unix workstation 14, Windows NT servers 16, a tandem server 18 and a Sun workstation 20. It will be understood that the managed nodes may be at the same location or the nodes may be at different locations.

The nodes 12, 14, 16, 18, 20 are networked to a management application 22 which may be implemented in the form of hardware and/or software. In addition to the nodes 12, 14, 16, 18, 20, the management application 22 may itself constitute a managed node.

Using an interface device, such as a computing device 24, and the management application 22, a user is able to define node groups by specifying criteria for the node groups. The user is also able to select nodes and/or node groups in relation to which queries are to be performed.

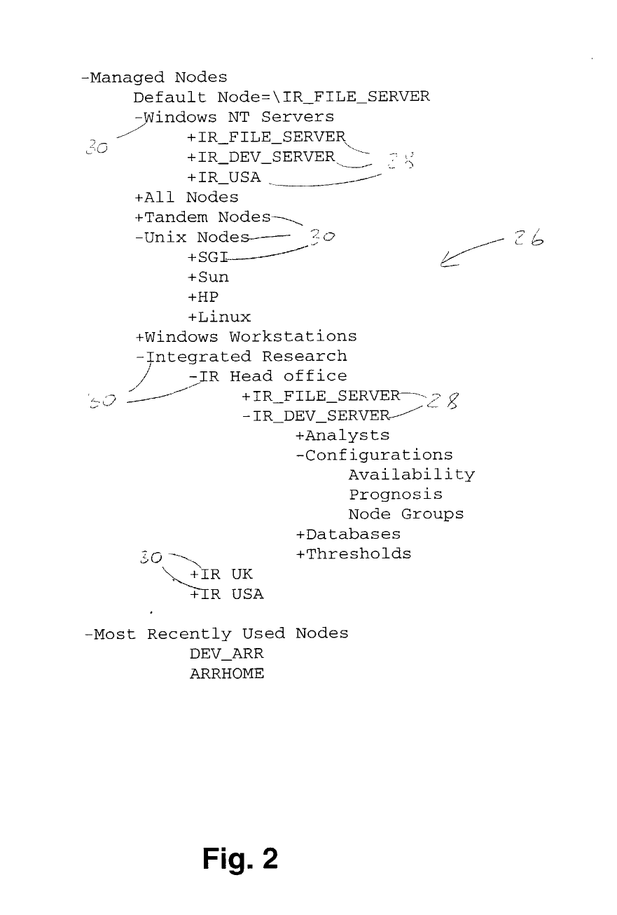

An example of a list of nodes and defined node groups is shown in the form of a managed nodes tree 26 in FIG. 2. The managed nodes tree 26 includes individual nodes 28 such as “IR_FILE_SERVER” and node groups 30 such as “Windows workstations”, “IR UK” and “Integrated Research”.

It can be seen from the managed nodes tree 26 that node groups may be defined on the basis of device type, for example the node groups “Windows NT servers”, “Windows workstations” or “LINUX”, and that node groups may also be defined on the basis of location, which may be location within the same organisation, such as “Integrated Research”, or location within the same locality or country, such as “IR UK”. It will also be understood that node groups may be defined on the basis of other user defined criteria based on aspects of operation of the nodes, such as “UNIX Running out of disk space”. To create this node group, a user would define criteria to cause selection of all nodes having a UNIX operating system and which also have one or more disk drives with less then 100 megabytes of disk space free.

It can also be seen from the managed nodes tree 26 that a node group may include sub-node groups. For example, a node group “UNIX nodes” may be defined to include all nodes with a UNIX operating system, and a sub-node group “LINUX” covering all nodes with a LINUX operating system may be defined. Of course, with this arrangement, all nodes in the sub-node group would satisfy the criteria for the parent node group as well as satisfying the criteria for the child node group of which the node is a member.

Since the nodes in a networked computing system will vary over time, the management application 22 is arranged to repeatedly re-evaluate the members of the node group at predetermined intervals by carrying out a check to ensure that all nodes having criteria specified for a node group are included as members of the node group. For example, the management application 22 may be arranged to re-evaluate the node groups once per day. In this way, when a new node is added to the network, the new node is identified by the system and included in the appropriate node group(s).

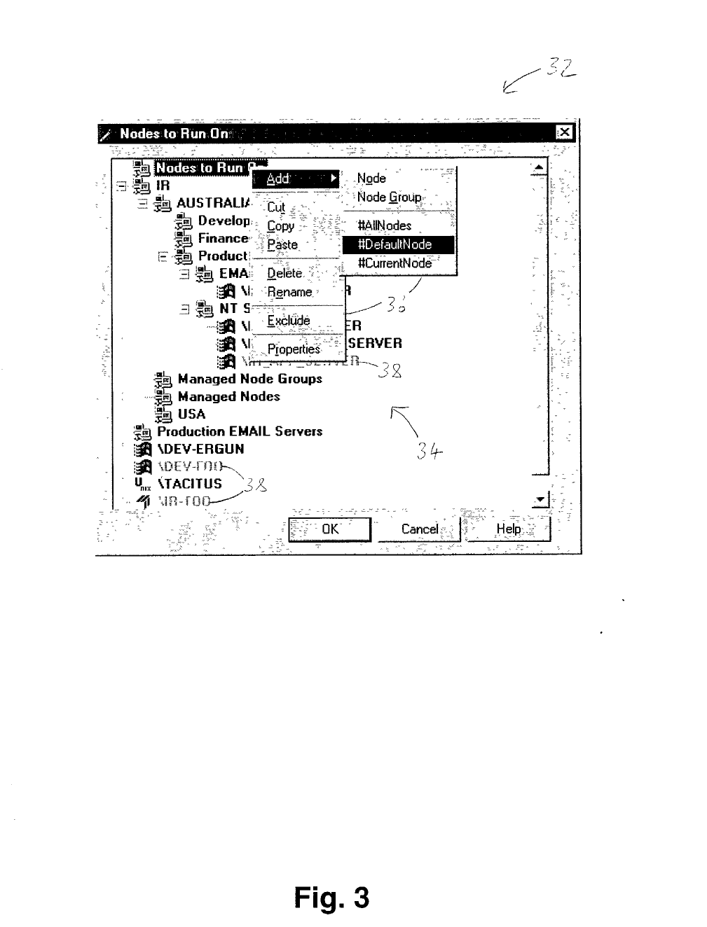

After defining the node groups 30 in the managed nodes tree 26 using the management application 22 and the computing device 24, a user is able to select at least one node and/or node group in relation to which a query is to be performed. A nodes to run on screen 28 which is used to select the appropriate nodes for a query is shown in FIG. 3.

The nodes to run on screen 28 includes a selected nodes tree 34 including nodes and node groups which have been selected by a user for querying. The nodes and node groups may be selected by transferring nodes and node groups from the managed nodes tree 26, for example by dragging and dropping, by using a pop-up menu 36, or in any other suitable way. It is also possible to exclude nodes 38 or node groups from a query, for example by using an exclude option on the pop-up menu 36. The pop-up menu 36 also enables new nodes and node groups to be added to the selected nodes tree 34.

It will be appreciated that various types of queries may be carried out on the selected nodes and/or node groups. For example, a query may be configured so as to retrieve records from one or more nodes in the selected nodes and/or node groups, so as to retrieve information from one or more nodes for storage into or replay from a database, so as to retrieve views from one or more nodes and trigger actions based on the records returned, and so on.

It will also be understood that a node may be included in the selected nodes tree 34 more than once, for example as an individual node and as a member of a node group.

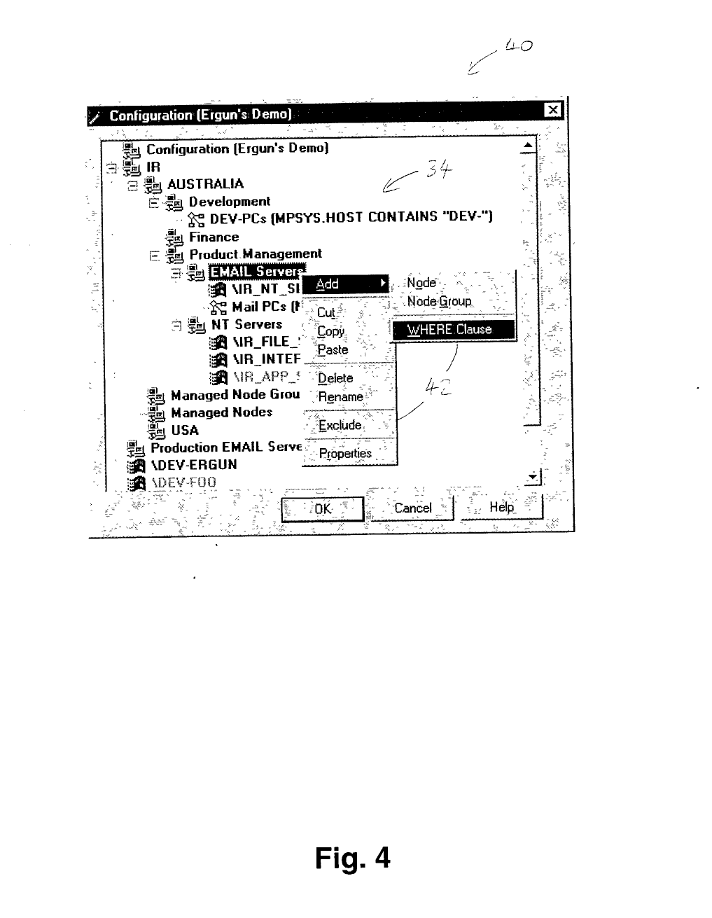

In FIG. 4, a configuration screen 40 for defining the filter criteria for the node groups is shown. The configuration screen 40 shows the selected nodes tree 34 which is the same as the selected nodes tree 34 shown in the nodes to the run on screen 32 of FIG. 3. Using the configuration screen 40, a user is able to select a node group and define appropriate filter criteria for the node group, for example by using a pop-up menu 42 and defining criteria using a “where clause” option in the pop-up menu 42 The “where cause” option enables a user to create a conditional expression. In addition to facilitating definition of filter criteria for a node group, the pop-up menu 42 also enables new nodes and node groups to be added to the selected nodes tree 34, and standard options to be selected, such as cut, copy, paste and rename.

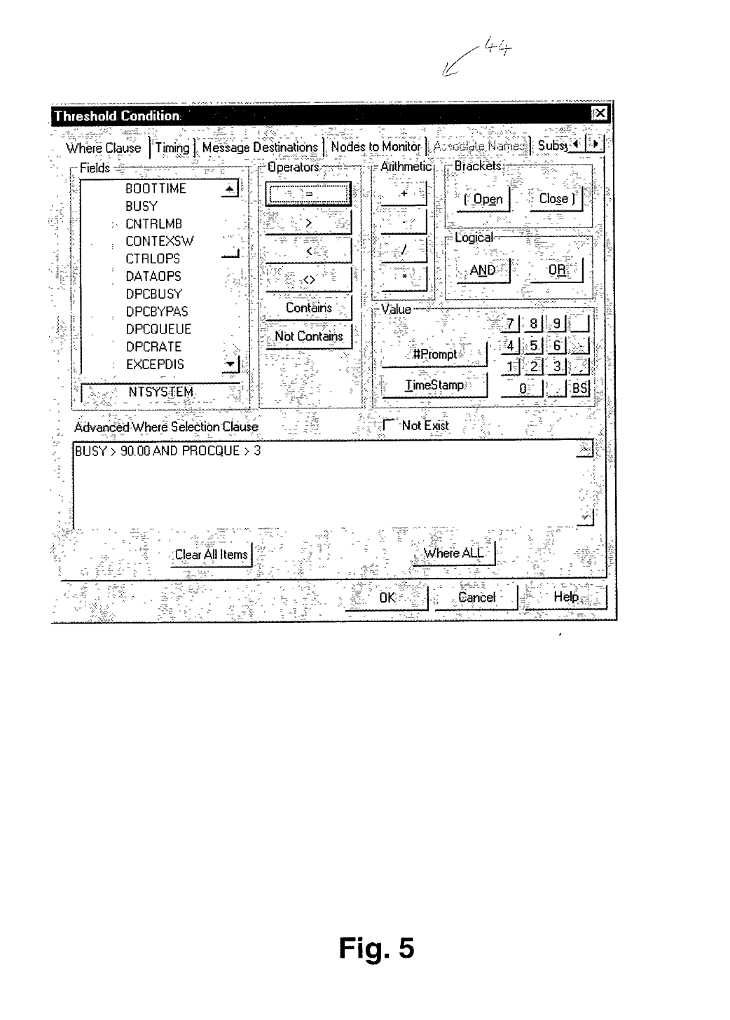

A condition entry screen 44 for use in defining a conditional expression is shown in FIG. 5. It will be understood that the condition entry screen 44 may be accessed in various ways, for example by selecting the “where clause” option from the pop-up menu 42 in the configuration screen 40, by performing a right mouse click and selecting properties from a pop-up box, and so on.

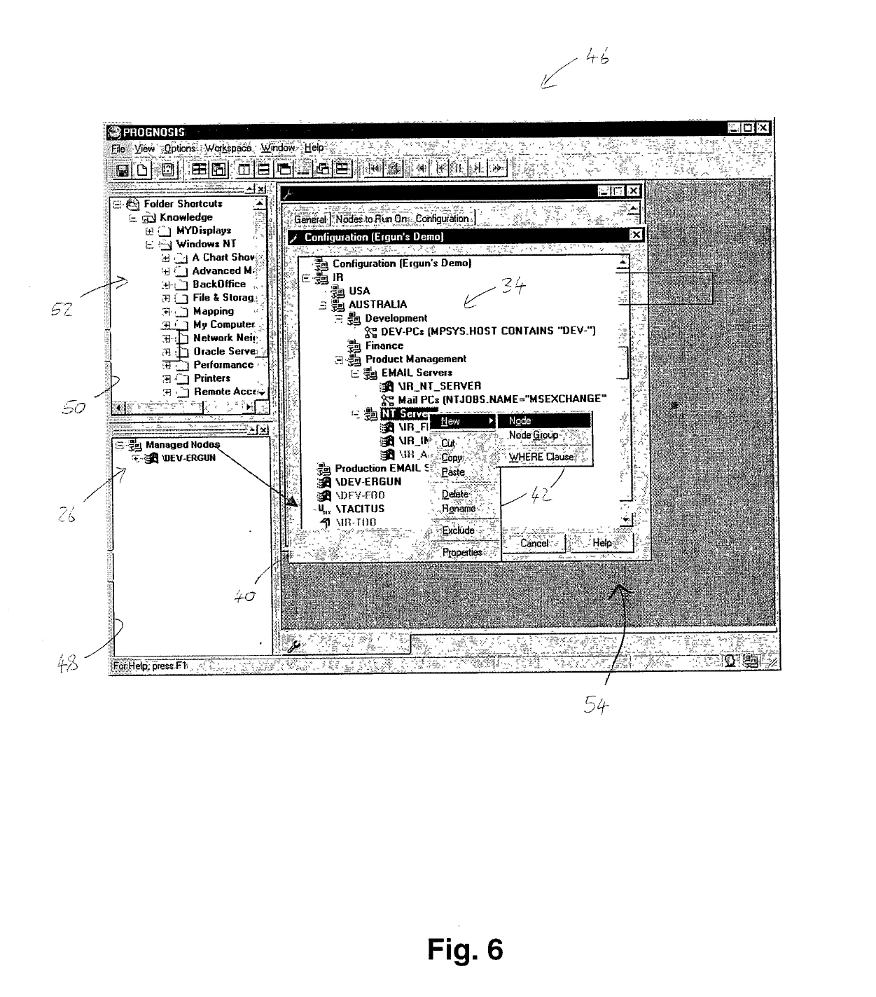

In FIG. 6, a management application screen 46 shown, the management application screen 46 being displayed to a user on the computing device 24 during use of the node management system 10.

The management application screen 46 includes a managed nodes window 48 in which is displayed the managed nodes tree 26, a service window 50 in which is displayed a service tree 52, and an active screen 54 in which may be displayed the nodes to run on screen 32 or the configuration screen 40. Using the management application screen, a user may transfer nodes and/or node groups from the managed nodes tree 26 or the service tree 52 to the selected nodes tree 34 shown in the nodes to run on screen 32 and the configuration screen 40.

Where methods and systems of the present invention are implemented by software applications, or partly implemented by software, then they may take the form of program code stored or available from computer readable media, such as CD-ROMS or any other machine readable media, the program code comprising instructions which, when loaded into a machine such as a computer, the machine then becomes a system for carrying out the invention. The computer readable media may include transmission media, such as cabling fibre optics or any other form of transmission media.

Modifications and variations as will be apparent to an addressee are deemed to be within the scope of the present invention.

The claims defining the invention are as follows:

1. A node management system, said system including:
means for grouping nodes together in a node group according to selected criteria, and for repeatedly re-evaluating the node group based on the selected criteria at predetermined intervals;
means for facilitating a selection of at least one node and/or node group; and
means for querying the selected at least one node and/or node group.

2. A system as claimed in claim 1, wherein the selected criteria is based on node location.

3. A system as claimed in claim 1, wherein the selected criteria is based on device type.

4. A system as claimed in claim 1, wherein the selected criteria is based on at least one aspect of operation of the nodes.

5. A system as claimed in claim 4, wherein the at least one aspect of operation of the nodes is defined using a conditional expression.

6. A system as claimed in claim 1, wherein the means for grouping nodes together, the means for facilitating selection of at least one node and/or node group, and the means for querying the selected at least one node and/or node group are implemented by a management application and a user interface device.

7. A system as claimed in claim 1, wherein the node group is re-evaluated at a predetermined interval.

8. A system as claimed in claim 7, wherein the predetermined interval is once per day.

9. A system as claimed in claim 1, wherein the means for grouping nodes together is arranged to group nodes together in node groups and sub-node groups.

10. A system as claimed in claim 1, wherein the system is arranged to display nodes to a user in the form of a managed nodes tree.

11. A system as claimed in claim 10, wherein the system is arranged to display selected nodes and/or node groups to a user in the form of a selected nodes tree.

12. A system as claimed in claim 11, wherein the means for facilitating selection of at least one node and/or node group includes means for facilitating transferral of nodes from the managed nodes tree to the selected nodes tree.

13. A system as claimed in claim 11, wherein the means for facilitating selection of at least one node and/or node group includes means for facilitating exclusion of at least one node and/or node group from the selected nodes tree.

14. A method of managing nodes, said method including the steps of:
grouping nodes together in a node group according to selected criteria;
repeatedly re-evaluating the node group on the basis of selected criteria at predetermined intervals;
facilitating selection of at least one node and/or node group; and
querying the selected at least one node and/or node group.

15. A method according to claim 14, wherein the selected criteria is based on node location.

16. A method according to claim 14, wherein the selected criteria is based on device type.

17. A method according to claim 14, wherein the selected criteria is based on at least one aspect of operation of the nodes.

18. A method according to claim 17, wherein the at least one aspect of operation of the nodes is defined using a conditional expression.

19. A method according to claim 14, wherein the steps of grouping nodes together, facilitating selection of at least one node and/or node group, and querying the selected at least one node and/or node group are implemented by a management application and a user interface device.

20. A method according to claim 14, wherein the node group is re-evaluated at a predetermined interval.

21. A method according to claim 20, wherein the predetermined interval is once per day.

22. A method according to claim 14, wherein the step of grouping nodes together further includes the step of grouping nodes together in node groups and sub-node groups.

23. A method according to claim 14, further including the step of displaying nodes to a user in the form of a managed nodes tree.

24. A method according to claim 23, further including the step of displaying selected nodes and/or node groups to a user in the form of a selected nodes tree.

25. A method according to claim 24, wherein the step of facilitating selection of at least one node and/or node group further includes the step of facilitating transferral of nodes from the managed nodes tree to the selected nodes tree.

26. A method according to claim 24, wherein the step of facilitating selection of at least one node and/or node group further includes the step of facilitating exclusion of at least one node and/or node group from the selected nodes tree.

27. A computer software program arranged to instruct a computing system to operate in accordance with a system according to claim 1.

28. A computer readable medium carrying a computer software program according to claim 27.
